(19) United States
(12) Patent Application Publication
(10) Pub. No.: US 2017/0171777 A1
(43) Pub. Date: Jun. 15, 2017

(54) Method of WLAN Mobility Set Construction

(71) Applicant: Nokia Solutions and Networks Oy, Espoo (FI)

(72) Inventors: Daniela Laselva, Klarup (DK); Jeroen Wigard, Klarup (DK)

(73) Assignee: Nokia Solutions and Networks Oy

(21) Appl. No.: 14/969,420

(22) Filed: Dec. 15, 2015

(51) Int. Cl. H04W 28/08; H04W 48/18; H04W 8/02; H04W 24/02; H04W 24/10

(52) U.S. Cl. CPC H04W 28/08; H04W 24/02; H04W 24/10; H04W 8/02; H04W 48/18; H04W 88/06

(57) ABSTRACT

A method of WLAN mobility set construction for mitigating the loss of data when a user equipment leaves a WLAN. A base station determines a location of and/or a mobility set for a user equipment in LTE-WLAN aggregation mode capable of communicating with an LTE cellular network and a wireless local area network. The wireless local area network has a plurality of access points for communicating with the user equipment. Each access point belongs to one of a plurality of mobility sets. The base station determines an access point for communicating with the user equipment and adjusts data flow decisions and/or mobility parameters for communication with the user equipment dependent on the determined location of and/or the mobility set for the user equipment.

### TECHNICAL FIELD

This invention relates generally to LTE-WLAN radio interworking and aggregation. More particularly, this invention relates to WLAN mobility set construction for configuration of mobility and flow control parameters/settings to mitigate the loss of data when a user equipment leaves a WLAN.

### BACKGROUND

This section is intended to provide a background or context to the invention disclosed below. The description herein may include concepts that could be pursued, but are not necessarily ones that have been previously conceived, implemented or described. Therefore, unless otherwise explicitly indicated herein, what is described in this section is not prior art to the description in this application and is not admitted to be prior art by inclusion in this section. Abbreviations that may be found in the specification and/or the drawing figures are defined below, after the main part of the detailed description section.

A Rel-13 Work Item (WI) “LTE-WLAN Radio Level Integration and Interworking Enhancement” (RP-150514) was approved at the RAN Plenary #67 meeting, during March 2015. Regarding the Radio Level Integration part, the WI leverages the LTE dual connectivity (DC) bearer split functionality (also known as option 3C) currently under standardization in 3GPP. This functionality is referred to as LTE-WLAN Aggregation (Rel-13 LWA). Additionally, the WI scope includes enhancements to the Rel-12 WLAN radio interworking functionality which adds further control to the 3GPP RAN over RRC_CONNECTED UEs, including the support of a dedicated traffic steering command to instruct traffic offloading/onloading based on UE measurement reporting. The Rel-13 WLAN interworking enhancements (Rel-13 LWI) are meant to enhance the Rel-12 WLAN radio interworking functionality providing further control to the eNB.

A new Rel-13 RAN2 Work Item (WI) “LTE-WLAN RAN Level Integration supporting legacy WLAN”, is referred to as LWA-IP Tunnel mode. This activity targets RAN level aggregation solutions which can operate with legacy WLAN deployments without any need for modifications to the deployed WLAN nodes. The support of legacy WLANs is achieved by relying on IP tunnelling between an eNB and a UE which is transparent to the WLAN network. The LWA-IP Tunnel mode builds upon the basic components of LWA and share the same new RRM framework and WLAN mobility concepts.

According to the Stage-2 endorsed 36.300 CR: “A WLAN mobility set is a set of one or more WLAN Access Points (APs) identified by one or more BSSID/HESSID/SSIDs, within which WLAN mobility mechanisms apply while the UE is configured with LWA bearer(s), i.e., the UE may perform mobility between WLAN APs belonging to the mobility set without informing the eNB. The eNB provides the UE with a WLAN mobility set. UE mobility to WLAN APs not belonging to the UE mobility set is controlled by the eNB e.g. based on measurement reports provided by the UE. A UE is connected to at most one mobility set at a time. All APs belonging to a mobility set share a common WT as termination point for Xw-C and Xw-U. The WLAN identifiers belonging to a mobility set may be a subset of all WLAN identifiers associated to the WT.”

Also, the UE can be configured with any of the agreed WLAN measurement events:
W1: “A WLAN becomes better than threshold” (motivation for the event was aggregation activation)
W2: UE cannot detect a WLAN in the mobility set better than threshold and a WLAN outside the mobility set becomes better than threshold (motivation for the event was Inter-mobility set mobility)
W3: UE cannot detect a WLAN in the mobility set better than threshold (motivation for the event was deactivation)

According to the Stage-2 endorsed 36.300 CR:

The eNB is expected to know which WLANs are under the control of the WT. This information will be likely provided by the WT over the direct Xw interface. That is, the WT provides the WLAN Ms (e.g. BSSIDs, HESSIDs, SSIDs) of all the WLANs under its control. However, it is completely open and up to the eNB how to construct WLAN mobility sets based on the complete set of WLANs under a WT.

WLAN networks provide typically Wi-Fi hotspot coverage which can be as small as a single room with walls that block radio waves, or as large as covering an entire large building which is achieved by using multiple overlapping WLAN APs. Multifloor/high raise buildings such as hotels, shopping malls, stadiums, airports, and museums, are examples of buildings where WLAN hotspots are typically available. A UE connects with a WLAN for coverage after entering the hotspot and while roaming within the area covered by the WLAN. When leaving a Wi-Fi hotspot, for example, when leaving a stadium or building, the UE will no longer be connected to the WLAN and will experience a WLAN radio coverage failure.

When the UE is operating in LWA mode, where the UE is able to connect to both the cellular and the Wi-Fi hotspot, leaving a Wi-Fi hotspot will result in the UE not being able to any longer use the WLAN link which is in use in the LWA configuration. Since the Wi-Fi radio coverage may drop abruptly at the edge of the hotspot, for example, due to the user exiting a door out of the WLAN coverage building, the flow control mechanism may be not be able to adjust quickly to slow down the amount of user plane data routed via WLAN. This may result in large user-plane buffering at the WT/AP which needs to be discarded and retransmitted via LTE once the UE's radio signal becomes too low. This wasted data transmission adds an undesirable burden on the wireless communication system because the data has to be sent twice. It also may result in a lower quality of service, for example, if video frames that were available under the WLAN connection are not transmitted in time to the UE before the UE abruptly leaves the WLAN connection.

WLANs are often used to cover indoor locations like shops and high rise buildings, and even for large sport arenas and stadiums. The users often experience WLAN coverage in those areas. With the aggregation of coverage through the introduction of LWA, these users may be connected to both the cellular and WLAN network simultaneously.

As typically the WLAN coverage will be better in the indoor locations, due to the fact that the cellular coverage may be provided from an antenna located outside the building while the WLAN APs are inside the building, most of the data may flow through the WLAN network while the control plane is covered through the cellular network. This has the advantage that mobility works fine when for instance leaving an office building covered by WLAN.

However, as the flow control may have pushed a lot of data to the WLAN network, some data may get lost and not be received by the user equipment before it has left the WLAN connection. Accordingly, there is a need to manage the flow of data to a user equipment that may transition from a WLAN connection to a cellular network connection. However, it is typically up to the eNB how to construct WLAN mobility sets based on the complete set of WLANs under a WT.

### BRIEF SUMMARY

This section is intended to include examples and is not intended to be limiting.

In accordance with an aspect of the invention, a method is provided of WLAN mobility set construction for mitigating the loss of data when a user equipment leaves a WLAN. A base station determines a location of and/or a mobility set for a user equipment in LTE-WLAN aggregation mode capable of communicating with an LTE cellular network and a wireless local area network. The wireless local area network has a plurality of access points for communicating with the user equipment. Each access point of the plurality of access points belongs to one of a plurality of mobility sets. The base station adjusts data flow decisions and/or mobility parameters for communication with the user equipment dependent on the determined location of and/or the mobility set for the user equipment.

The wireless local area network may have at least one access point at a hotspot-edge and at least one access point at a hotspot-center. The hotspot-edge is an area of coverage determined as being where the user equipment may leave the wireless local area network. The hotspot-center is an area of coverage determined as being where the user equipment will not leave the wireless local area network. If the location of the user equipment is the hotspot-edge and/or the mobility set for the user equipment is for the hotspot-edge, the data flow decisions and/or mobility parameters may be adjusted to mitigate loss of data. If the location of the user equipment is the hotspot-center and/or the mobility set for the user equipment is for the hotspot-center, the data flow decisions and/or mobility parameters may be adjusted to maximize the data throughput. The location may be determined, for example, by the mobility set, which may be determined through measurements performed by the user equipment.

The mobility set can be determined by planning or by monitoring mobility events in the past (for example if UEs often leave the WLAN area after being connected to AP x, then one may add AP x to the cell edge mobility set). As an example, the mobility set may be determined by network planning, by statistics on mobility events and/or UE measurements.

In accordance with another aspect of the invention, an apparatus comprises at least one processor, and at least one memory including computer program code. The at least one memory and the computer program code are configured to, with the at least one processor, cause the apparatus to perform at least the following: determine at least one of a location of and a mobility set for a user equipment in LTE-WLAN aggregation mode capable of communicating with an LTE cellular network and a wireless local area network, wherein the wireless local area network has a plurality of access points for communicating with the user equipment, each access point of the plurality of access points belonging to one of a plurality of mobility sets; and adjust at least one of data flow decisions and mobility parameters for communication with the user equipment dependent on the determined said at least one of the location of and the mobility set for the user equipment.

In accordance with another aspect of the invention, a computer program product comprises a computer-readable medium bearing computer program code embodied therein for use with a computer. The computer program code comprising: code for determining at least one of a location of and a mobility set for a user equipment in LTE-WLAN aggregation mode capable of communicating with an LTE cellular network and a wireless local area network, wherein the wireless local area network has a plurality of access points for communicating with the user equipment, each access point of the plurality of access points belonging to one of a plurality of mobility sets; code for determining an access point of the plurality of access points for communicating with the user equipment; and code for adjusting at least one of data flow decisions and mobility parameters for communication with the user equipment dependent on the determined said at least one of the location of and the mobility set for the user equipment.

In accordance with another aspect of the invention, a method includes configuring a first access point of a plurality of access points of a wireless local area network to belong to a first mobility set of a plurality of mobility sets. The wireless local area network has a plurality of access points for communicating with a user equipment in LTE-WLAN aggregation mode capable of communicating with an LTE cellular network and the wireless local area network. A second access point is configured to belong to a second mobility set of the plurality of mobility sets. The second mobility set is different than the first mobility set and at least one of data flow decisions and mobility parameters for communication with the user equipment are adjusted dependent on the mobility set to which an access point in communication with the user equipment belongs.

### BRIEF DESCRIPTION OF THE DRAWINGS

In the attached Drawing Figures:

FIG. 1 is a block diagram of one possible and non-limiting exemplary system in which the exemplary embodiments may be practiced;

FIG. 2A is a logic flow diagram for a method of WLAN Mobility Set Construction, and illustrates the operation of an exemplary method, a result of execution of computer program instructions embodied on a computer readable memory, functions performed by logic implemented in hardware, and/or interconnected means for performing functions in accordance with exemplary embodiments;

FIG. 2B is a logic flow diagram for a method of WLAN Mobility Set Construction, and illustrates the operation of another exemplary method, a result of execution of computer program instructions embodied on a computer readable memory, functions performed by logic implemented in hardware, and/or interconnected means for performing functions in accordance with exemplary embodiments;

FIG. 2C is a logic flow diagram for a method of WLAN Mobility Set Construction, and illustrates the operation of still another exemplary method, a result of execution of computer program instructions embodied on a computer readable memory, functions performed by logic implemented in hardware, and/or interconnected means for performing functions in accordance with exemplary embodiments;

FIG. 2D is a logic flow diagram for a method of WLAN Mobility Set Construction, and illustrates the operation of yet another exemplary method, a result of execution of computer program instructions embodied on a computer readable memory, functions performed by logic implemented in hardware, and/or interconnected means for performing functions in accordance with exemplary embodiments;

FIG. 3 illustrates a UE connected to a cellular network before entering a hotspot;

FIG. 4 illustrates the UE entering a WiFi hotspot-edge area and communicating with a hotspot-edge WT/AP of a WiFi hotspot;

FIG. 5 illustrates the UE moving to a hotspot-center area and communicating with a hotspot-center AP;

FIG. 6 illustrates the UE moving to another hotspot-center area and communicating with another hotspot-center AP;

FIG. 7 illustrates the UE moving back to the hotspot-edge area and communicating with the hotspot-edge WT/AP; and

FIG. 8 illustrates the UE leaving the hotspot-edge area and communicating with the cellular network.

### DETAILED DESCRIPTION OF THE DRAWINGS

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The exemplary embodiments herein describe techniques for WLAN Mobility Set Construction for mitigating the loss of data when a user equipment leaves a WLAN. Additional description of these techniques is presented after a system into which the exemplary embodiments may be used is described.

This invention addresses a method for the eNB to construct the WLAN Mobility Sets such to identify when the UE location may get closer to the edge of a Wi-Fi hotspot which may result in the imminent loss of the hotspot coverage. The method efficiently assists LWA's scheduling and/or flow control operations and reduces the amount of data or avoids LWA user-plane buffering at the WT/AP at the time the user equipment leave a WLAN hotspot. Consequently it reduces the burden of (PDCP) retransmissions from the eNB and reduces the UE's QoS degradation due to larger latency.

Typically, when WLAN coverage is available, most of the data transmitted to the UE may flow through the WLAN network while the control plane is covered through the cellular network. Since the flow control may have pushed a lot of data to the WLAN network, some data may get lost and not be received by the UE before losing the WLAN connection. Since the eNB is able to construct WLAN mobility sets based on the complete set of WLANs under a WT, there is the opportunity for the flow of data to be managed so that a UE can transition from a WLAN connection to a cellular network connection while mitigating the loss of available data from the WLAN.

In accordance with an exemplary embodiment, a method is provided enabling an eNB to construct WLAN Mobility Sets that identifies when the location of a moving UE may be getting close to the edge of a Wi-Fi hotspot which may result in the loss of the hotspot coverage. The method efficiently assists in LWA scheduling and flow control operations. Data that is transmitted but not yet received by the UE via the user-plane buffering at the WT/AP is limited or avoided when leaving a WLAN hotspot, consequently reducing or avoiding the need for (PDCP) retransmissions from the eNB.

In accordance with an exemplary embodiment, multiple (at least two) mobility sets are used. Within each mobility set the access points have certain common characteristics which benefit from different ways of how to split data between WLAN and LTE and/or by applying different mobility configurations to the user equipment. There is a direct mapping from certain mobility sets as to how data is split between the WLAN and LTE and/or to which mobility parameters are sent to the HE.

In accordance with an exemplary embodiment, the base station knows which WLAN access points belong to each mobility set and the user equipment measures the WLAN access points that are close to its location (for example, the access points the user equipment can detect). For example, the user equipment may report this information to the base station when the user equipment detects an access point that is not within the currently configured mobility set.

Through this reporting the base station knows which mobility set to configure for the user equipment. For example, when it receives a measurement that an access point not belonging to the current mobility set of the UE meets the trigger conditions then the base station knows the user equipment should be configured with a new mobility set to which the newly measured access point belongs. The base station thus also knows how to configure the data transmission split between the WLAN and LTE, and/or the mobility configurations to be used.

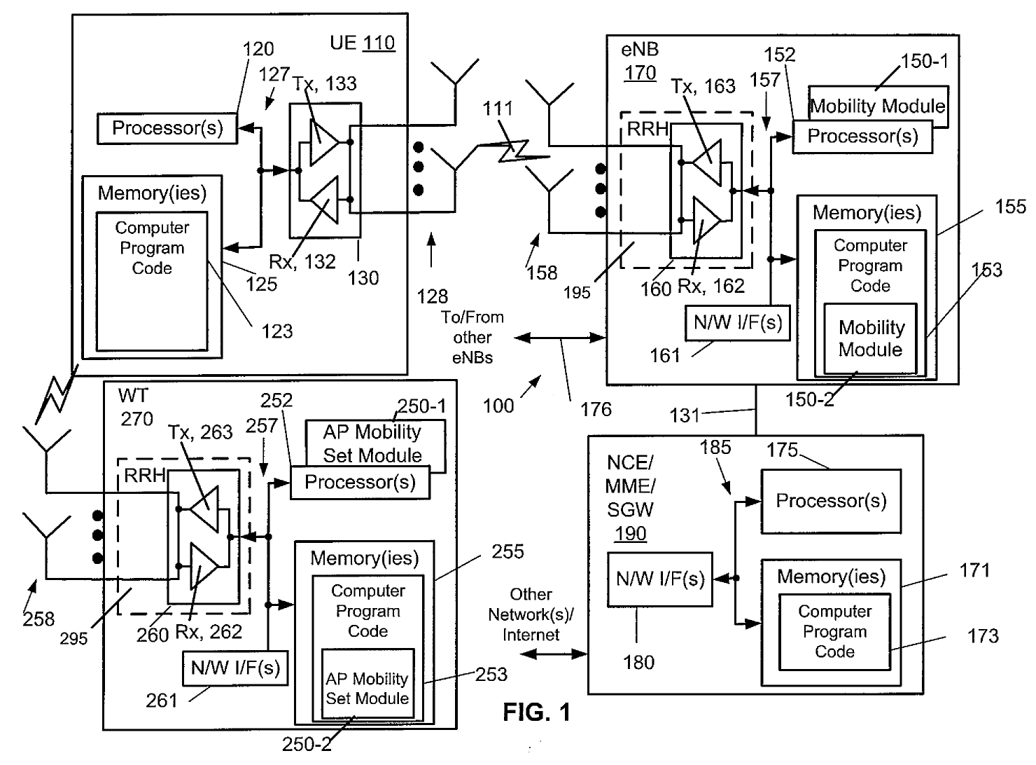

Turning to FIG. 1, this figure shows a block diagram of one possible and non-limiting exemplary system in which the exemplary embodiments may be practiced. In FIG. 1, a user equipment (UE) 110 is in wireless communication with a wireless network 100. A UE is a wireless, typically mobile device that can access a wireless network. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. For instance, the one or more memories 125 and the computer program code 123 may be configured to, with the one or more processors 120, cause the user equipment 110 to perform one or more of the operations as described herein. The UE 110 communicates with eNB 170 via a wireless link 111.

The eNB (evolved NodeB) 170 is a base station (e.g., for LIE, long term evolution) that provides access by wireless devices such as the UE 110 to the wireless network 100. The eNB 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The eNB 170 includes a Mobility Set module 150, comprising one of or both parts 150-1 and/or 150-2, which may be implemented in a number of ways. The Mobility Set module 150 may be implemented in hardware as Mobility Set module 150-1, such as being implemented as part of the one or more processors 152. The Mobility Set module 150-1 may be implemented also as an integrated circuit or through other hardware such as a programmable gate array. In another example, the Mobility Set module 150 may be implemented as Mobility Set module 150-2, which is implemented as computer program code 153 and is executed by the one or more processors 152. For instance, the one or more memories 155 and the computer program code 153 are configured to, with the one or more processors 152, cause the eNB 170 to perform one or more of the operations as described herein. The one or more network interfaces 161 communicate over a network such as via the links 176 and 131. Two or more eNBs 170 communicate using, e.g., link 176. The link 176 may be wired or wireless or both and may implement, e.g., an X2 interface.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195, with the other elements of the eNB 170 being physically in a different location from the RRH, and the one or more buses 157 could be implemented in part as fiber optic cable to connect the other elements of the eNB 170 to the RRH 195.

The WT/AP (WLAN Termination Access Point) 270 is a WiFi access point located for communication at a hotspot-edge area of the WiFi coverage area. The WT/AP provides access by wireless devices such as the UE 110 to the wireless network 100, which may be a LWA (LTE-WLAN Aggregation) network. The WT/AP 270 includes one or more processors 252, one or more memories 255, one or more network interfaces (N/W I/F(s)) 261, and one or more transceivers 260 interconnected through one or more buses 257. Each of the one or more transceivers 260 includes a receiver, Rx, 262 and a transmitter, Tx, 263. The one or more transceivers 260 are connected to one or more antennas 258. The one or more memories 255 include computer program code 253. The WT/AP 270 includes an AP Mobility Set module 250, comprising one of or both parts 250-1 and/or 250-2, which may be implemented in a number of ways. The AP Mobility Set module 250 may be implemented in hardware as AP Mobility Set module 250-1, such as being implemented as part of the one or more processors 252. The AP Mobility Set module 250-1 may be implemented also as an integrated circuit or through other hardware such as a programmable gate array. In another example, the AP Mobility Set module 250 may be implemented as AP Mobility Set module 250-2, which is implemented as computer program code 253 and is executed by the one or more processors 252. For instance, the one or more memories 255 and the computer program code 253 are configured to, with the one or more processors 252, cause the WT/AP 270 to perform one or more of the operations as described herein.

The wireless network 100 may include a network control element (NCE) 190 that may include MME (Mobility Management Entity)/SGW (Serving Gateway) functionality, and which provides connectivity with a further network, such as a telephone network and/or a data communications network (e.g., the Internet). The eNB 170 is coupled via a link 131 to the NCE 190. The link 131 may be implemented as, e.g., an S1 interface. The NCE 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the NCE 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, 171 and 271 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, 171 and 271 may be means for performing storage functions. The processors 120, 152, 175 and 252 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, 175 and 252 may be means for performing functions, such as controlling the UE 110, eNB 170, WT/AP, AP, and other functions as described herein.

In accordance with an exemplary embodiment, an eNB constructs a dedicated WLAN Mobility Set, termed herein as the “hotspot-edge set”. The hotspot-edge set includes one or more access points that have been configured as a WT, these WT/APs are at one or more of the edges of the WLAN coverage area.

In accordance with an exemplary embodiment, when the UE enters the Wi-Fi hotspot-edge area (that is, the UE enters the area covered by the hotspot-edge Mobility Set WT/AP) the eNB will learn that the UE has entered the WLAN and trigger appropriate actions with regard to LWA flow control to minimize the loss of data (routed via the WLAN) at the occurrence of the UE leaving the Wi-Fi hotspot.

Stated otherwise, while the UE is detected as being in the hotspot-edge area, the wireless communication with the UE is controlled to use the hotspot-edge Mobility Set where the data flow decisions, such as the flow control parameters, are adjusted to minimize loss of data.

In accordance with an exemplary embodiment, flow control may be adjusted to optimize the user throughput. As the throughput on the radio interface varies due to varying radio conditions, interference and other users sharing the same resources, the throughput of data to and from a user varies. The sending side, for example, the eNB, is not aware of the instantaneous throughput and therefore flow control typically ensures that a certain amount of data is available in the receiving node, for example, the WiFi access points. The amount of data may be adjusted to be large enough to cope with the varying throughput and ensure that a buffer is not running empty. At the same time having a lot of data in the buffer at the receiving side increases the risk of data loss when, for example, the user moves away from the receiving node. Therefore the amount of data should not be too large.

There are a number of different ways of implementing flow control in accordance with an exemplary embodiment. For example, when used with LTE dual connectivity and LWA, the receiving side monitors its buffer status and has an internal target. The receiving side (e.g., the WiFi access point) will ask in regular intervals, or based on the status of its buffer, for a certain amount of data, trying to ensure the target amount of data in the buffer is met. The transmitting side (e.g., the eNB) decides how much data is actually granted based on this request and, for example, may grant the transmission of a smaller amount of data than requested for a UE located at a hotspot-edge as compared to the amount of data requested and transmitted for a UE located at a hotspot-center.

Another example of flow control implementation is to start with a certain number of packets per time unit which then is either adjusted by the receiving side (e.g., the WiFi access point) based on the buffer status or transmitting side (e.g., the eNB) based on acknowledgements or indication from the receiving side that the data has been transmitted to the UE. The data flow decisions, such as the flow control parameters, adjusted based on the location can be many, but they would lead to a lower buffer occupancy when the UE is located at a hotspot-edge than when the UE is located at a hotspot-center.

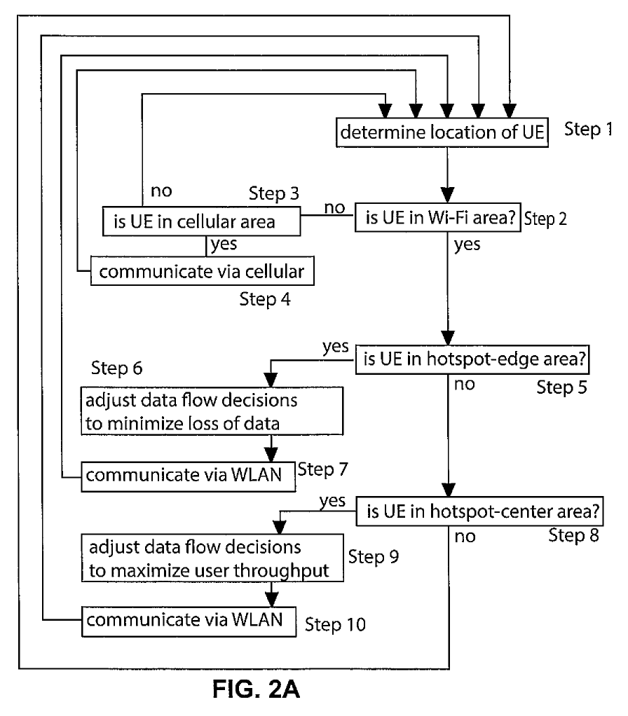

FIGS. 2A-2D are logic flow diagrams for a method of WLAN Mobility Set Construction for mitigating the loss of data when a user equipment leaves a WLAN. These figures further illustrates the operation of exemplary methods, a result of execution of computer program instructions embodied on a computer readable memory, functions performed by logic implemented in hardware, and/or interconnected means for performing functions in accordance with exemplary embodiments. For instance, the Mobility Set module 150 may include multiples ones of the blocks in FIG. 2A-2D, where each included block is an interconnected means for performing the function in the block. The blocks in FIG. 2A-2D are assumed to be performed by a base station such as eNB 170, e.g., under control of the Mobility Set module 150 at least in part.

In accordance with an exemplary embodiment shown in FIG. 2A, a location of a user equipment is determined (Step 1). The user equipment is capable of communicating with a cellular network and a wireless local area network. The wireless local area network is configured to at least transmit data to the user equipment. The wireless local area network has at least one access point at a hotspot-edge and at least one access point at a hotspot-center. The hotspot-edge is an area of coverage predetermined as being where the user equipment may leave the wireless local area network. The hotspot-center is an area of coverage predetermined as being where the user equipment will not leave the wireless local area network. It is determined if the UE is in a WiFi area (Step 2), if not then the UE is only in a cellular area (Step 3) and communication with the UE is via the cellular network (Step 4). If the determined location of the UE is in a WiFi area (Step 2), then it is determined if the location is at a hotspot-edge area (Step 5) or in a hotspot-center area (Step 8). If the determined location of the UE is in the hotspot-edge are, data flow parameters are adjusted for communication with the user equipment so that the loss of data is minimized if the UE should leave the WiFi hotspot while data is still available to transmit to the UE. That is, if the determined location is the hotspot-edge area, the data flow parameters are adjusted to mitigate loss of data (Step 6), and communication with the UE is done through the WLAN (Step 7). If the determined location of the UE is a hotspot-center area (Step 8), then data flow parameters are adjusted for communication with the user equipment so that the maximum data throughput is provided to the UE (Step 9) and communication with the UE is done through the WLAN (Step 10). Note, there may be still communication through the LTE network as well (potentially only control-plane communication) for instance in case of LWA, but typically most if not all of the user-plane communication will be sent through the WiFi network.

In accordance with an exemplary embodiment shown in FIG. 2B, a location of a user equipment is determined (Step 1). If the determined location of the UE is in the hotspot-edge area (Step 2), mobility parameters are adjusted for communication with the user equipment so that the loss of data is minimized if the UE should leave the WiFi hotspot while data is still available to transmit to the UE. That is, if the determined location is the hotspot-edge area, the mobility parameters are adjusted to mitigate loss of data (Step 3), and communication with the UE is done through the WLAN (Step 4). If the determined location of the UE is a hotspot-center area (Step 5), then mobility parameters are adjusted for communication with the user equipment so that the maximum data throughput is provided to the UE (Step 6) and communication with the UE is done through the WLAN (Step 7).

In accordance with an exemplary embodiment shown in FIG. 2C, a mobility set for a user equipment is determined (Step 1). If the determined mobility set for the UE is for the hotspot-edge area (Step 2), data flow decisions are adjusted for communication with the user equipment so that the loss of data is minimized if the UE should leave the WiFi hotspot while data is still available to transmit to the UE. That is, if the determined mobility set is for the hotspot-edge area, the data flow decisions are adjusted to mitigate loss of data (Step 3), and communication with the UE is done through the WLAN (Step 7). If the determined mobility set of the UE is a hotspot-center area (Step 8), then data flow decisions are adjusted for communication with the user equipment so that the maximum data throughput is provided to the UE (Step 9) and communication with the UE is done through the WLAN (Step 10).

In accordance with an exemplary embodiment shown in FIG. 2D, a mobility set for a user equipment is determined (Step 1). If the determined mobility set for the UE is for the hotspot-edge area (Step 2), mobility parameters are adjusted for communication with the user equipment so that the loss of data is minimized if the UE should leave the WiFi hotspot while data is still available to transmit to the UE. That is, if the determined mobility set is for the hotspot-edge area, the mobility parameters are adjusted to mitigate loss of data (Step 3), and communication with the UE is done through the WLAN (Step 7). If the determined mobility set of the UE is a hotspot-center area (Step 8), then mobility parameters are adjusted for communication with the user equipment so that the maximum data throughput is provided to the UE (Step 9) and communication with the UE is done through the WLAN (Step 10).

Without in any way limiting the scope, interpretation, or application of the claims appearing below, a technical effect of one or more of the example embodiments disclosed herein is mitigating the loss of data when a user equipment leaves a WLAN.

The eNB may learn of the UE entering the hotspot edge-area from measurements made by the UE. In accordance with an exemplary embodiment, the UE detects a WiFi AP which belongs to the hotspot mobility set, which is constructed based on network planning. The hotspot mobility set can also be constructed through measurements from monitoring past mobility events in the area. For example, if monitoring of activity indicates that a UE typically leaves the WLAN after being connected to certain WLAN APs, then in the future a hotspot edge mobility set out can be automatically constructed based on this noted mobility event.

In accordance with an exemplary embodiment, the eNB constructs one or more hotspot-edge WLAN Mobility Sets and one or more hotspot-center WLAN Mobility Sets for the WLANs controlled by a WT.

The eNB categorizes the WLANs under a WT as hotspot-edge and hotspot-center, distinguishing the WLAN APs which are at the edge of the radio coverage area of the WLAN, from the WLAN APs which are within the center of the coverage area.

A WLAN AP is categorized to be at the edge of the radio coverage area of a WLAN network if a UE moving outside the given WLAN AP's radio coverage area will experience a WLAN coverage failure. That is, if moving out of a particular WLAN AP's radio coverage area does not place the UE in the coverage area of another WLAN AP of the WLAN, then the UE will move outside the WLAN hotspot and lose WLAN coverage. In this case, the WLAN AP is considered to be at the edge of the radio coverage area of the WLAN network.

The eNB configures the UEs targeted for and/or identified to start operating in LWA/LWI/LWA-IP Tunnel mode with the identified one or more hotspot-edge WLAN Mobility Sets and one or more hotspot-center WLAN Mobility Sets. Mobility sets which are specific to a given UE or group of UEs may be created and optimized on the basis of UE or UE group specific mobility pattern.

For example, if the UE is at the hotspot-edge, then it is likely that the UE will soon need a hand-over to the cellular network. This may be because, for example, the UE will be leaving an office building where the UE is connected to a WiFi network. In this case, it is crucial to make the handover happen fast (for example, in the case of events w1, w2, w3, described above, or even inter eNB mobility). As a result, timers, for example, time-to-trigger handover, may be kept short. On the other hand, if a UE is located at or near the top of the WiFi covered office building, preferably handovers are avoided, so timers may be kept long. As an alternative to timers, hysteresis, power levels, quality levels, and the like may be used to adjust the handover events.

Based on UE WLAN measurement reporting (triggered by inter-Mobility Set mobility events) the eNB will learn when the UE enters the Wi-Fi hotspot-edge area (when the UE enters the hotspot-edge Mobility Set) and will trigger appropriate actions for LWA flow control/scheduling and/or LWI Traffic Steering command. For example, the eNB may lower the flow control thresholds related to the target buffer size at the WT/AP.

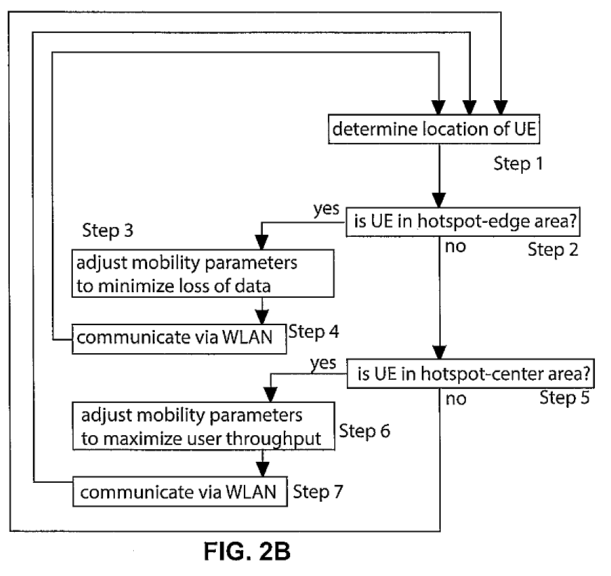

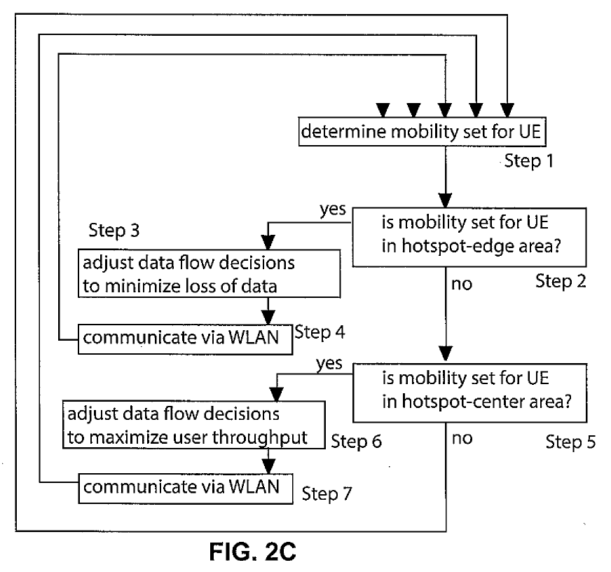

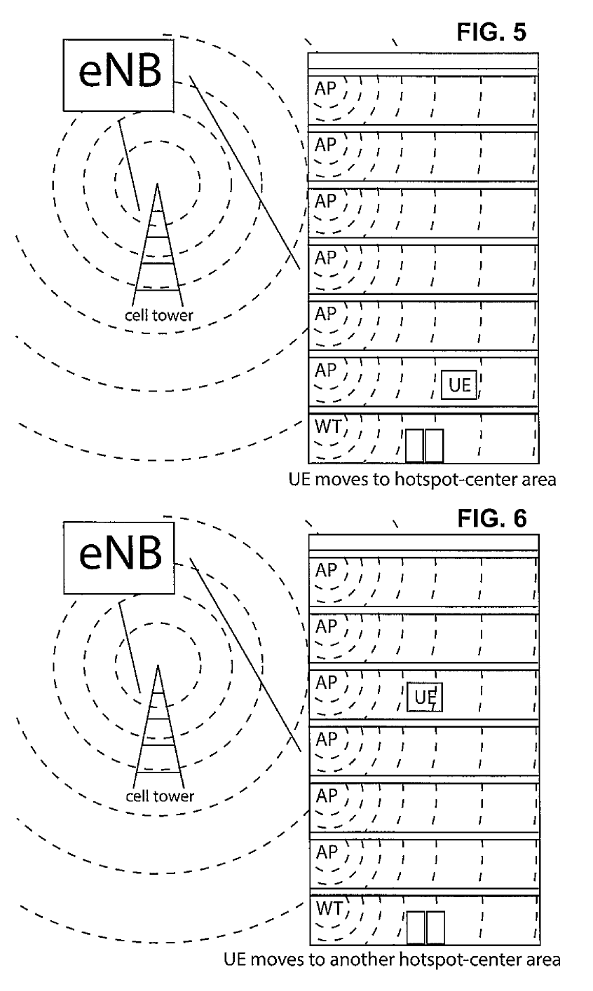

As a non-limiting example, the eNB can construct the WLAN Mobility Sets for a multi-floor high rise building as illustrated in FIGS. 3 through 8. The WLAN network topology can be assumed to be available at the eNB as provided by WLAN O&M or by other advanced means.

In the example shown in FIGS. 3-8, a UE starts out outside of the WiFi hotspot and is communicating in a cellular coverage area under the control of an eNB (FIG. 3). There is a WiFi hotspot in the high rise building consisting of a WT/AP located at the ground floor. The area covered by the WT/AP is configured as a hotspot-edge Mobility Set because it is likely that the UE will enter and leave the WLAN of the WiFi hotspot through the doors at the ground floor level. When the UE enters the ground floor of the high rise building, the UE enters the hotspot-edge area serviced by the WT/AP.

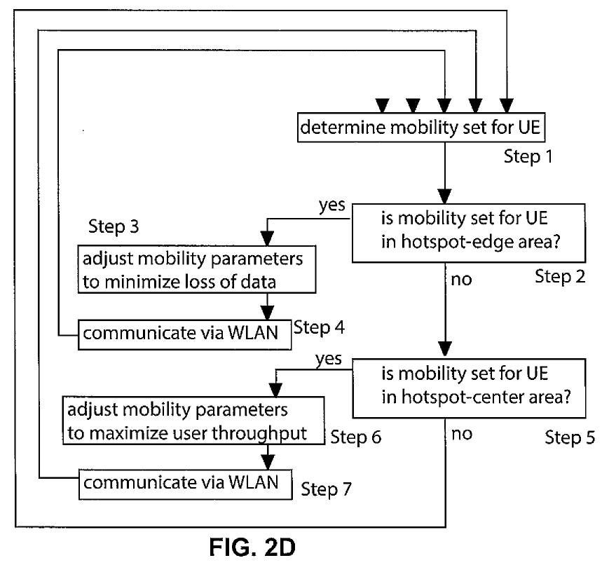

If the UE goes up a floor then the UE enters a hotspot-center area and is serviced by an AP of the WLAN that is configured as a hotspot-center Mobility Set (FIG. 5). The UE will not leave the WLAN when located at the hotspot-center area, since this area is at an upper floor with no likely direct exit from the high rise building without going through the doors on the ground floor. When the location of the UE is detected as being in the hotspot-center area, there is much less likely a chance, as compared to the hotspot-edge area, that the UE will exit the WLAN with data available for transmission through the WLAN.

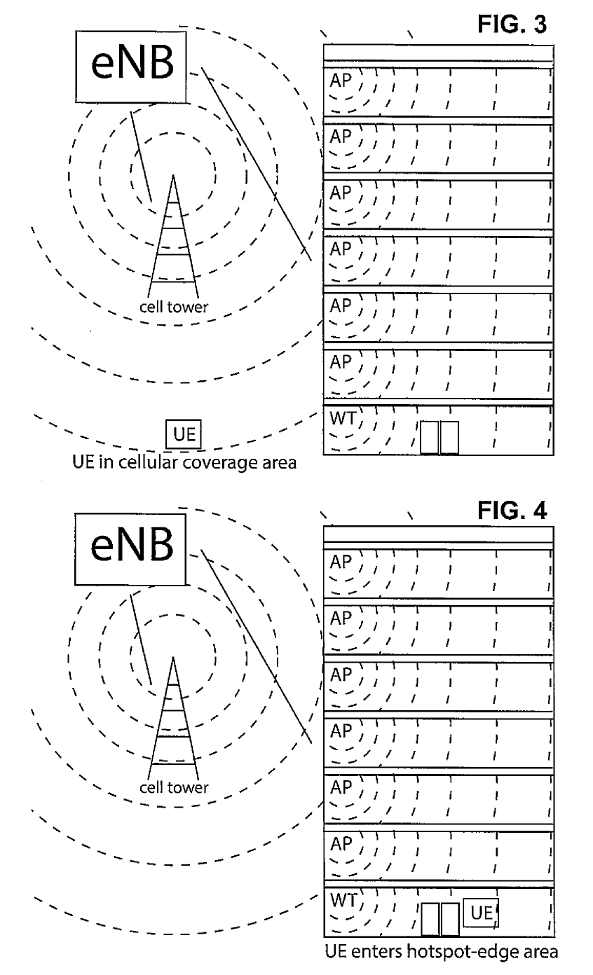

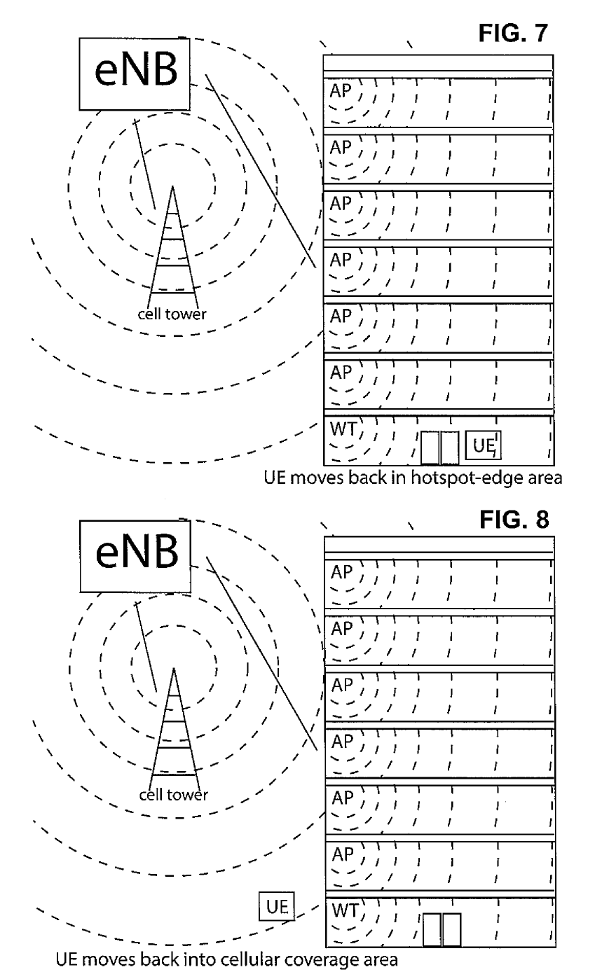

If the UE continues up a through the high rise floors, it remains serviced by APs that are in the hotspot-center area (FIG. 6). However, if the UE moves back down to the ground floor, it is again in the hotspot-edge area serviced by the WT/AP located at the ground floor, which has been configured as the hotspot-edge Mobility Set (FIG. 8).

In accordance with an exemplary embodiment, the hotspot-edge WLAN Mobility Set includes all the WLAN APs under the control of the given WT which are located at the ground floor. Whenever the UE enters this floor and has been connected to a WLAN AP included in the hotspot-center WLAN Mobility Set, this UE may be marked as a UE which likely is leaving the building and the data flow decisions, such as the flow control parameters, should be adjusted to minimize the loss of data, i.e. to minimize the number of retransmissions. In this case, it may be determined if the user equipment moves from the hotspot-center to the hotspot-edge. In this exemplary embodiment, the data flow parameters are adjusted only if the user equipment moves from the hotspot-center to the hotspot-edge.

After adjusting data flow parameters, the location of the user equipment can be again detected and if the UE has gone up to a high floor and the location is again at the hotpot-center, then the user equipment is communicated with using normal data flow parameters. If after adjusting data flow parameters, the location of the user equipment can be further detected and if the location is not at the hotspot-edge, and if the further detected location is still within the local area network, than it can be assumed that the UE is at the hotspot-center area and communication with the user equipment can again be done using normal data flow parameters using the WLAN. However, if the further detected location is not within the wireless area network, then communicating with the user equipment is done using the cellular network.

When the UE enters this floor and has not been connected to the WLAN AP included in the hotspot-center WLAN Mobility Set, this UE can be expected to likely stay in the building and the data flow decisions, such as the flow control parameters, can be optimized to guarantee good data flow through the WLAN.

In accordance with the example shown in FIGS. 3-8, the hotspot-center WLAN Mobility Set includes all the WLAN APs under the control of the given WT which are located at the floors above the ground floor since it is not likely that a user will leave the WLAN from any of the floors above the ground floor.

In accordance with an exemplary embodiment, a base station determines at least one of a location of and a mobility set for a user equipment in LTE-WLAN aggregation mode capable of communicating with an LTE cellular network and a wireless local area network. The wireless local area network has a plurality of access points for communicating with the user equipment. Each access point of the plurality of access points belongs to one of a plurality of mobility sets. The base station determines an access point of the plurality of access points for communicating with the user equipment. The base station adjusts at least one of data flow decisions and mobility parameters for communication with the user equipment dependent on the determined said at least one of the location of and the mobility set for the user equipment.

The plurality of mobility sets may include a hotspot-edge mobility set and a hotspot-center mobility set. The hotspot-edge mobility set is configured for a hotspot-edge area of coverage determined as being where the user equipment may leave the wireless local area network. The hotspot-center mobility set is configured for a hotspot-center area of coverage determined as being where the user equipment will not leave the wireless local area network.

If the access point communicating with the user equipment belongs to the hotspot-edge mobility set, then at least one of data flow decisions and mobility parameters are adjusted by the base station to mitigate data loss.

If the access point communicating with the user equipment belongs to the hotspot-center mobility set, then at least one of data flow decisions and mobility parameters are adjusted by the base station to maximize user throughput.

The mobility set may be determined by the base station dependent on at least measurements reported by the user equipment related to at least one access point of the plurality of access points.

The data flow decisions may include at least one of splitting of data transmission to the user equipment between the wireless local area network and the LTE cellular network.

In addition, the base station, may construct at least two mobility sets of the plurality of mobility sets. Each of the two mobility sets may include access points having common characteristics related to at least one of data flow decisions and mobility.

For example, as shown in FIGS. 3-8, the APs above the ground floor may belong to a mobility set constructed by the base station to have a common characteristic enabling user throughput to be maximized by adjusting data flow decisions and mobility parameters. In this case, the APs on the floors above ground floor belong to the hotspot-center mobility set configured for the hotspot-center area of coverage where the user equipment will not exit the building and leave the wireless local area network.

APs, including the WT, on the ground floor may belong to a mobility set constructed by the base station to have a common characteristic enabling the mitigation of data loss by adjusting data flow decisions and mobility parameters. In this case, the APs on the ground floor belong to the hotspot-edge mobility set configured for the hotspot-edge area of coverage where the user equipment may exit the building from the ground floor and leave the wireless local area network.

The user equipment may be configured with a mobility set of the plurality of mobility sets based on at least measurements reported by the user equipment before adjusting at least one of the data flow decisions and a mobility configuration.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium (e.g., memories 125, 155, 171, 255 or other device) that may be any media or means that can contain, store, and/or transport the instructions for use by or in connection with an instruction execution system, apparatus, or device, such as a computer. A computer-readable storage medium does not comprise propagating signals.

If desired, the different functions discussed herein may be performed in a different order and/or concurrently with each other. Furthermore, if desired, one or more of the above-described functions may be optional or may he combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:

3GPP third generation partnership project

ANDSF access network detection and selection function

AP (WLAN) access point

eNB enhanced node B (LTE base station)

ID identifier

IW interworking

I/F interface

LTE long term evolution

LWA LTE-WLAN Aggregation

MME mobility management entity

MO Mobile Originating

NCE network control element

N/W network

PDCP packet data convergence protocol

RAN radio access network

RRC Radio Resource Control

RRH remote radio head

Rx receiver

SGW serving gateway

Tx transmitter

UE user equipment

WLAN wireless local area network

WT WLAN termination

What is claimed is:

1. A method, comprising:
determining, by a base station, at least one of a location of and a mobility set for a user equipment in LTE-WLAN aggregation mode capable of communicating with an LTE cellular network and a wireless local area network, wherein the wireless local area network has a plurality of access points for communicating with the user equipment, each access point of the plurality of access points belonging to one of a plurality of mobility sets; and
adjusting, by the base station, at least one of data flow decisions and mobility parameters for communication with the user equipment dependent on the determined said at least one of the location of and the mobility set for the user equipment.

2. The method according to claim 1, wherein the plurality of mobility sets includes a hotspot-edge mobility set and a hotspot-center mobility set, wherein the hotspot-edge mobility set is configured for a hotspot-edge area of coverage determined as being where the user equipment may leave the wireless local area network, and the hotspot-center mobility set is configured for a hotspot-center area of coverage determined as being where the user equipment will not leave the wireless local area network.

3. The method according to claim 2, wherein if an access point communicating with the user equipment belongs to the hotspot-edge mobility set, then said at least one of data flow decisions and mobility parameters are adjusted by the base station to mitigate data loss.

4. The method according to claim 2, wherein if an access point communicating with the user equipment belongs to the hotspot-center mobility set, then said at least one of data flow decisions and mobility parameters are adjusted by the base station to maximize user throughput.

5. The method according to claim 1, wherein the mobility set is determined by the base station dependent on at least measurements reported by the user equipment related to at least one access point of the plurality of access points.

6. The method according to claim 1, wherein the data flow decisions include at least one of splitting of data transmission to the user equipment between the wireless local area network and the LTE cellular network.

7. The method according to claim 1, further comprising, constructing, by the base station, at least two mobility sets of the plurality of mobility sets wherein each of said at least two mobility sets includes access points having common characteristics related to at least one of data flow decisions and mobility.

8. The method according to claim 1, further comprising configuring the user equipment with a mobility set of the plurality of mobility sets based on at least measurements reported by the user equipment before adjusting at least one of the data flow decisions and a mobility configuration.

9. A apparatus, comprising:
at least one processor; and
at least one memory including computer program code,
the at least one memory and the computer program code configured to, with the at least one processor, cause the apparatus to perform at least the following:
determine at least one of a location of and a mobility set for a user equipment in LTE-WLAN aggregation mode capable of communicating with an LTE cellular network and a wireless local area network, wherein the wireless local area network has a plurality of access points for communicating with the user equipment, each access point of the plurality of access points belonging to one of a plurality of mobility sets; and
adjust at least one of data flow decisions and mobility parameters for communication with the user equipment dependent on the determined said at least one of the location of and the mobility set for the user equipment.

10. The apparatus according to claim 9, wherein the plurality of mobility sets includes a hotspot-edge mobility set and a hotspot-center mobility set, wherein the hotspot-edge mobility set is configured for a hotspot-edge area of coverage determined as being where the user equipment may leave the wireless local area network, and the hotspot-center mobility set is configured for a hotspot-center area of coverage determined as being where the user equipment will not leave the wireless local area network.

11. The apparatus according to claim 10, wherein if an access point communicating with the user equipment belongs to the hotspot-edge mobility set, then said at least one of data flow decisions and mobility parameters are adjusted by the base station to mitigate data loss.

12. The apparatus according to claim 10, wherein if an access point communicating with the user equipment belongs to the hotspot-center mobility set, then said at least one of data flow decisions and mobility parameters are adjusted by the base station to maximize user throughput.

13. The apparatus according to claim 9, wherein the mobility set is determined dependent on at least measurements reported by the user equipment related to at least one access point of the plurality of access points.

14. The apparatus according to claim 9, wherein the data flow decisions include at least one of splitting of data transmission to the user equipment between the wireless local area network and the LTE cellular network.

15. The apparatus according to claim 9, wherein the at least one memory and the computer program code are configured to, with the at least one processor, cause the apparatus to further perform:
construct at least two mobility sets of the plurality of mobility sets wherein each of said at least two mobility sets includes access points having common characteristics related to at least one of data flow decisions and mobility.

16. The apparatus according to claim 9, wherein the at least one memory and the computer program code are configured to, with the at least one processor, cause the apparatus to further perform:
configure the user equipment with a mobility set of the plurality of mobility sets based on at least measurements reported by the user equipment before adjusting at least one of the data flow decisions and a mobility configuration.

17. A computer program product comprising a computer-readable medium bearing computer program code embodied therein for use with a computer, the computer program code comprising:
code for determining at least one of a location of and a mobility set for a user equipment in LTE-WLAN aggregation mode capable of communicating with an LTE cellular network and a wireless local area network, wherein the wireless local area network has a plurality of access points for communicating with the user equipment, each access point of the plurality of access points belonging to one of a plurality of mobility sets; and
code for adjusting at least one of data flow decisions and mobility parameters for communication with the user equipment dependent on the determined said at least one of the location of and the mobility set for the user equipment.

18. A method comprising:
configuring a first access point of a plurality of access points of a wireless local area network to belong to a first mobility set of a plurality of mobility sets, wherein the wireless local area network has a plurality of access points for communicating with a user equipment in LTE-WLAN aggregation mode capable of communicating with an LTE cellular network and the wireless local area network; and
configuring a second access point to belong to a second mobility set of the plurality of mobility sets, wherein the second mobility set is different than the first mobility set and at least one of data flow decisions and mobility parameters for communication with the user equipment are adjusted dependent on the mobility set to which an access point in communication with the user equipment belongs.

19. The method according to claim 18, wherein the plurality of mobility sets includes a hotspot-edge mobility set and a hotspot-center mobility set, wherein the hotspot-edge mobility set is configured for a hotspot-edge area of coverage determined as being where the user equipment may leave the wireless local area network, and the hotspot-center mobility set is configured for a hotspot-center area of coverage determined as being where the user equipment will not leave the wireless local area network.

20. The method according to claim 19, wherein the first access point and the second access point are configured so that if one of the first access point and the second access point belongs to the hotspot-edge mobility set, then said at least one of data flow decisions and mobility parameters are adjusted by the base station to mitigate data loss, and if one of the first access point and the second access point belongs to the hotspot-center mobility set, then said at least one of data flow decisions and mobility parameters are adjusted by the base station to maximize user throughput.
